(19) United States
(12) Patent Application Publication
(10) Pub. No.: US 2015/0206620 A1
(43) Pub. Date: Jul. 23, 2015

(54) METHOD FOR PREPARING TRANSPARENT CONDUCTOR, PRESSING ROLL FOR THE SAME, TRANSPARENT CONDUCTOR PREPARED FROM THE SAME AND DISPLAY APPARATUS COMPRISING THE SAME

(71) Applicant: SAMSUNG SDI CO., LTD., Yongin-si (KR)

(72) Inventors: Dong Myeong SHIN, Uiwang-si (KR); Young Kwon KOO, Uiwang-si (KR); Oh Hyeon HWANG, Uiwang-si (KR); Kyoung Ku KANG, Uiwang-si (KR)

(21) Appl. No.: 14/603,065

(22) Filed: Jan. 22, 2015

(30) Foreign Application Priority Data
Jan. 22, 2014 (KR) 10-2014-0008030

(51) Int. Cl. H01B 1/22; B32B 37/00; B32B 15/06; B32B 37/10

(52) U.S. Cl. CPC H01B 1/22; B32B 37/1027; B32B 37/0053; B32B 15/06; B32B 2307/202; B32B 2262/103; B32B 2309/12; B32B 2457/208

(57) ABSTRACT

A method for preparing a transparent conductor includes providing a laminate, the laminate including a base layer and a conductive network on the base layer and including metal nanowires, and pressing the laminate using a first pressing roll that has a surface hardness of about Shore D-50 to about Shore D-90.

### CROSS-REFERENCE TO RELATED APPLICATION

Korean Patent Application No. 10-2014-0008030, filed on Jan. 22, 2014, in the Korean Intellectual Property Office, and entitled: “Method for Preparing Transparent Conductor, Pressing Roll for the Same, Transparent Conductor Prepared from the Same and Display Apparatus Comprising the Same” is incorporated by reference herein in its entirety.

### BACKGROUND

1. Field

Embodiments relate to a method for preparing a transparent conductor, a pressing roll used for the same, a transparent conductor prepared using the same, and a display including the transparent conductor.

2. Description of the Related Art

A transparent conductor is used in a variety of fields, such as touchscreen panels used in displays, flexible displays, and the like. It is desirable for transparent conductors to have excellent properties in terms of transparency, sheet resistance, and the like.

### SUMMARY

Embodiments are directed to a method for preparing a transparent conductor, the method including providing a laminate, the laminate including a base layer, and a conductive network on the base layer and including metal nanowires, and pressing the laminate using a first pressing roll that has a surface hardness of about Shore D-50 to about Shore D-90.

The first pressing roll may have a coefficient of friction of less than about 0.8.

The first pressing roll may have a vulcanized rubber surface and the vulcanized rubber may have 20 wt % or more amount of sulfur.

The pressing may be performed using a second pressing roll facing the first pressing roll at a predetermined distance therefrom.

The second pressing roll may have a higher Shore D surface hardness than the first pressing roll.

The second pressing roll may have a stainless steel surface or a chrome-coated stainless steel surface.

A nip pressure applied to the laminate by the first and second pressing rolls may range from about 0.2 MPa to about 10 MPa.

The method may further include, after pressing the laminate, applying a matrix composition to the conductive network and curing the matrix composition to form a conductive layer.

The matrix composition may include a hexafunctional acrylate monomer and a trifunctional acrylate monomer.

The method may further include patterning the conductive layer.

The metal nanowires may include silver nanowires.

Embodiments are also directed to a pressing roll for preparing a transparent conductor from a laminate that includes a base layer and a conductive layer, the conductive layer being on the base layer and including metal nanowires and a matrix, the pressing roll including a first pressing roll having a surface hardness of about Shore D-50 to about Shore D-90, and a second pressing roll disposed opposite the first pressing roll and configured to press the laminate therebetween.

The first pressing roll may have a vulcanized rubber surface.

The second pressing roll may have a stainless steel surface or a chrome-coated stainless steel surface.

Embodiments are also directed to a transparent conductor, including a base layer, and a conductive layer on the base layer and including metal nanowires and a matrix, the transparent conductor having a sheet resistance deviation of less than about 20%, as represented by Equation 1:

Sheet Resistance Deviation RS_{d}=|(RSₘₐₓ−RS_{avg})/RS_{avg}×100| (1).

In Equation 1, the maximum sheet resistance RSₘₐₓ is a maximum value among sheet resistance values measured for plural sections, and the average sheet resistance RS_{avg} is an average of the maximum sheet resistance RSₘₐₓ and minimum sheet resistance RSₘᵢₙ values among the sheet resistance values measured for the plural sections, the minimum sheet resistance RSₘᵢₙ being a minimum value among the sheet resistance values measured for the plural sections.

The transparent conductor may be formed by pressing a laminate using a first pressing roll having a surface hardness of about Shore D-50 to about Shore D-90, the laminate including the base layer and a conductive network containing the metal nanowires on the base layer.

The matrix may be formed of a composition containing a hexafunctional acrylate monomer and a trifunctional acrylate monomer.

The first pressing roll may have a vulcanized rubber surface.

The pressing may be performed using a second pressing roll facing the first pressing roll at a predetermined distance therefrom.

Embodiments are also directed to a display including the transparent conductor according to an embodiment.

### BRIEF DESCRIPTION OF THE DRAWINGS

Features will become apparent to those of skill in the art by describing in detail example embodiments with reference to the attached drawings in which:

FIG. 1 illustrates a diagram of a method for preparing a transparent conductor according to one embodiment.

FIG. 2 illustrates a diagram of a method for preparing a transparent conductor according to another embodiment.

FIG. 3 illustrates a sectional view of a transparent conductor according to one embodiment.

FIG. 4 illustrates a sectional view of a transparent conductor according to another embodiment.

FIG. 5 illustrates a sectional view of an optical display according to one embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey example implementations to those skilled in the art.

In the drawing figures, the dimensions of layers and regions may be exaggerated for clarity of illustration. Like reference numerals refer to like elements throughout.

As used herein, the term “(meth)acrylate” may refer to “acrylate” and/or “methacrylate”.

Hereinafter, a method for preparing a transparent conductor according to an example embodiment will be described with reference to FIG. 1.

FIG. 1 is a diagram of the method 100 of preparing a transparent conductor according to an example embodiment.

According the present example embodiment, referring to FIG. 1, the method 100 of preparing a transparent conductor includes pressing a stack structure 110 (hereinafter, referred to as the “laminate”) including a base layer and a conductive network 120 by a first pressing roll 130. The conductive network 120 includes a metal nanowire. In the method 100 of preparing a transparent conductor according to the present example embodiment, the conductive network 120 is pressed by the first pressing roll 130, which may help improve the density of the metal nanowire, and may provide a transparent conductor having high conductivity and a low sheet resistance deviation, which may exhibit excellent electrical conductivity.

The first pressing roll 130 is brought into contact with the conductive network 120 during the pressing. The first pressing roll 130 has a surface hardness of about D-50 to about D-90 as measured by a Shore D durometer. Thus, the method 100 according to the embodiment can prevent tearing of the metal nanowire of the conductive network 120 while inhibiting scratching at the surface of the laminate.

In this application, Shore D hardness of a pressing roll is measured in accordance with ASTM D2240.

The first pressing roll 130 may have a Shore D hardness of, for example, about D-75 to about D-90. Within this range, the laminate may not be scratched at the surface thereof, and the transparent conductor formed by pressing may provide a lower sheet resistance deviation and higher conductivity.

The transparent conductor prepared using the first pressing roll 130 may have a sheet resistance deviation of about less than 20%. For example, the sheet resistance deviation of the transparent conductor may be about 16% or less. Within this range, the transparent conductor may exhibit only a small increase in resistance even when the flexibility and size thereof is increased. Such a transparent conductor may be advantageously applied to large area displays, flexible displays, touchscreen panels, and the like.

In this application, the sheet resistance deviation of the transparent conductor is measured after dividing an area of the transparent conductor. Specifically, the area of the pressed transparent conductor is divided into plural sections with the same area. For example, after dividing the area of the transparent conductor into ten sections measuring 50 mm×50 mm, sheet resistance is measured for each section to obtain plural sheet resistance values, followed by calculating a sheet resistance deviation according to Equation 1:

Sheet resistance deviation RS_{d}=|(RSₘₐₓ−RS_{avg})/RS_{avg}×100| (1),

In Equation 1, the maximum sheet resistance RSₘₐₓ is a maximum value among the sheet resistance values measured for the plural sections, and the average sheet resistance RS_{avg} is an average of the maximum and minimum values RSₘₐₓ and RSₘᵢₙ among the sheet resistance values measured for the plural sections. Here, the minimum sheet resistance RSₘᵢₙ is a minimum value among the sheet resistance values measured for the plural sections.

The sheet resistance may include contact sheet resistance, non-contact sheet resistance, and the like. For example, the contact sheet resistance may be measured using an R-CHEK RC2175 (EDTM Inc), and the non-contact sheet resistance may be measured using an EC-80P (NAPSON Corporation).

The surface of the first pressing roll 130 may be formed of, for example, vulcanized rubber or stainless steel (steel use stainless; SUS), or the first pressing roll 130 may be a Cr-coated SUS roll. The vulcanized rubber refers to synthetic rubber to which about 20% by weight (wt %) or more of sulfur is added. The synthetic rubber may include natural rubber, styrene butadiene rubber, and the like. By way of example, the first pressing roll 130 may be formed of a vulcanized rubber such as ebonite. In this case, the transparent conductor may experience considerably less tearing of the metal nanowire and/or scratching. In addition, the metal nanowire may be more effectively compressed by pressing. The ebonite may have a sulfur content of 20 wt % or more.

The surface of the first pressing roll has a Shore D hardness of about D-50 to about D-90; the first pressing roll 130 may have various attributes in terms of internal hardness, material, and shape. For example, the first pressing roll may be a roll having a hollow structure, or a roll having a solid structure. Further, the interior of the first pressing roll 130 may be formed of the same material as the surface, or a different material.

The first pressing roll 130 may have a low coefficient of friction. In this case, tearing of the metal nanowire caused by the first pressing roll 130 may be further inhibited, thereby further reducing the sheet resistance deviation of the transparent conductor. For example, the first pressing roll 130 may have a coefficient of friction of less than about 0.8. By way of example, the first pressing roll 130 may have a coefficient of friction of about 0.08 to about 0.72. Within this range, tearing of the metal nanowire may be more effectively inhibited. Further, within this range, the metal nanowire may be more effectively compressed by pressing. In this case, the method according to one embodiment may further reduce the sheet resistance deviation of the transparent conductor.

The first pressing roll 130 may have a low surface roughness (Ra or Rq). In this case, scratching at the transparent conductor can be reduced during pressing. For example, the first pressing roll 130 may have a surface roughness of about 0.8 S or less. Within this range, scratching at the laminate may be further reduced during pressing, while further lowering the sheet resistance deviation of the transparent conductor.

In the method 100 according to the present example embodiment, pressing may include moving the laminate at a predetermined feeding speed while applying a predetermined nip pressure to the laminate by the first pressing roll 130.

The feeding speed is a moving speed when the laminate passes through the pressing roll, and may range, for example, from about 1 m/min to about 20 m/min. Within this range, the sheet resistance deviation may be more effectively reduced by pressing.

The nip pressure is a pressure applied to the transparent conductor by the first pressing roll, and may range, for example, from about 0.2 MPa to about 10 MPa. Within this range, the sheet resistance deviation may be effectively reduced by pressing.

The laminate may be transferred in a roll-to-roll manner, by a conveyer belt, etc.

When the laminate including the base layer 110 and the conductive network 120 is pressed through the pressing process as described above, a transparent conductor including the base layer 110 and the conductive network 160 containing densified metal nanowires may be obtained. This conductive network 160 may provide improved conductivity and electric conductivity through improvement in contact between the conductors of the conductive network.

The conductive network 120 may have a thickness of, for example, about 60 nm to about 200 nm. Within this range, the metal nanowire may be effectively compressed by pressing, which may help reduce the sheet resistance deviation of the transparent conductor. In addition, the prepared transparent conductor may be used for transparent electrode films.

In the method 100 according to the present example embodiment, the laminate may be transferred through compression and rotation of the first pressing roll 130. Here, the rotational speed of the first pressing roll 130 may vary depending on a desired feeding speed of the laminate. For example, the first pressing roll 130 may have a rotational speed of about 1 m/min to about 20 m/min, and the rotation direction of the first pressing roll 130 may be the same as the feeding direction of the laminate. In this case, the laminate may be easily moved, and pressing by the first pressing roll 130 may be more effectively performed.

The method for preparing a transparent conductor according to the embodiment may further include, after pressing, applying a matrix composition to the conductive network and curing the composition to form a conductive layer. The matrix may help prevent oxidation of the conductive network, for example, the metal nanowires, caused by an external environment, while improving adhesion of the conductive network layer to the base layer.

In addition, the method for preparing a transparent conductor according to the present example embodiment may further include patterning the transparent conductor, after applying the matrix composition to the conductive network and curing the composition to form the conductive layer. Patterning may be completely or partially performed with respect to the conductive layer. Patterning may be carried out by a suitable method, for example, dry etching, wet etching, or the like.

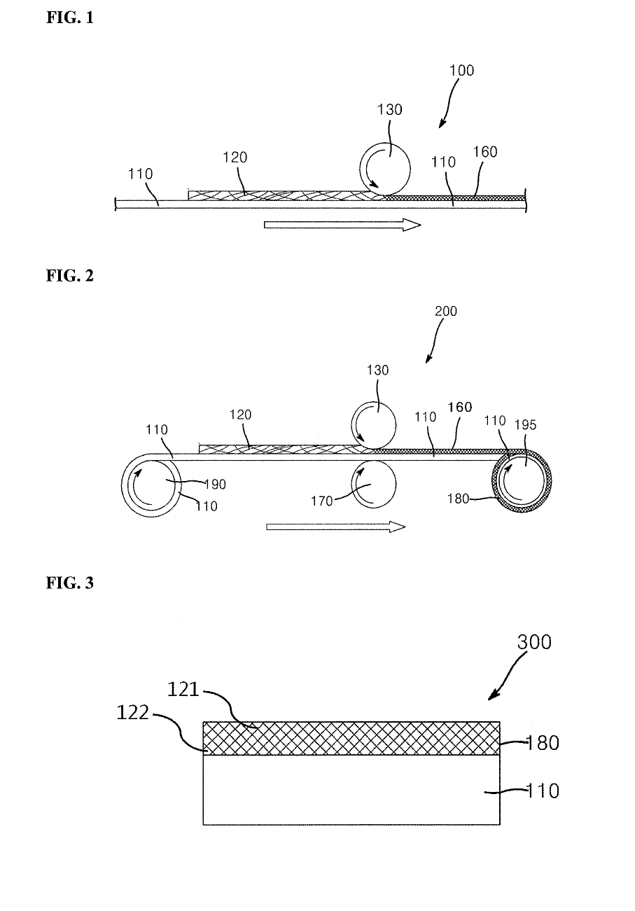

Next, a method 200 of preparing a transparent conductor according to another example embodiment will be described with reference to FIG. 2.

FIG. 2 is a diagram of a method 200 of preparing a transparent conductor according to another example embodiment.

The method 200 according to the present example embodiment includes pressing a transparent conductor by a first pressing roll 130 and a second pressing roll 170 facing each other. The method 200 according to this embodiment is substantially the same as the method 100 of one embodiment except that the first pressing roll and the second pressing roll 170 facing each other are used together in pressing. Thus, the second pressing roll 170, and a relationship between the first and second pressing rolls 130, 170, will be mainly described hereinafter.

According to the present example embodiment, the second pressing roll 170 is brought into contact with the base layer 110 of the laminate during pressing. As a result, a predetermined pressure may also be applied to the base layer. In addition, the laminate may be further compressed as compared to pressing by the first pressing roll 130 alone, whereby the transparent conductor may have a lower sheet resistance deviation and improved conductivity.

The first and second pressing rolls 130, 170 face each other, with a predetermined gap defined therebetween. The gap is a distance between the first and second pressing rolls 130, 170. The laminate is pressed by the first and second pressing rolls 130, 170, while passing through the gap. The size of the gap may be properly adjusted depending upon the thickness of the laminate. For example, the gap may have a size of about 100 μm or less, for example about greater than 0 μm to about 100 μm or about 50 μm to about 100 μm. Within this range, the conductive network may be effectively pressed while providing better uniformity in conductivity.

The second pressing roll 170 may have a lower elasticity than the first pressing roll 130. For example, the elasticity of the second pressing roll 170 may be about 0.1 times to about 0.9 times that of the first pressing roll 130. Within this range of elasticity of the second pressing roll, the metal nanowire of the transparent conductor may be more effectively compressed while further reducing the sheet resistance deviation of the transparent conductor.

In an embodiment, the surface of the second pressing roll 170 may have the same hardness, surface roughness, and/or coefficient of friction as that of the first pressing roll 130. In another embodiment, the surface of the second pressing roll 170 may have different hardness, surface roughness, and/or coefficient of friction than that of the first pressing roll 130.

For example, the second pressing roll 170 may have a Shore D hardness higher than or equal to that of the first pressing roll 130. In this case, the thickness of the transparent conductor may be effectively reduced by pressing. In an implementation, the second pressing roll 170 may have a Shore D hardness of about D-90 or higher, for example, about D-100 or higher. Within this range, the thickness of the transparent conductor may be further reduced by pressing.

The second pressing roll 170 may have a surface roughness greater than or equal to that of the first pressing roll 130. Specifically, the second pressing roll 170 may have a surface roughness of about 0.8 S or less. Within this range, the second pressing roll 170 may allow reduction in scratching at the surface of the transparent conductor, thereby further lowering the sheet resistance deviation of the transparent conductor.

The second pressing roll 170 may be formed of, for example, vulcanized rubber or metal. The vulcanized rubber may be a synthetic rubber containing about 20 wt % or more of sulfur. The second pressing roll 170 may be formed of metal, such as Steel Use Stainless (SUS), or may be a Cr-coated SUS roll. In this case, the second pressing roll 170 may allow the thickness of the laminate to be further reduced.

The laminate may be transferred through compression and rotation of the second pressing roll 170. Here, the rotational speed of the second pressing roll 170 may be the same as or different from that of the first pressing roll 130. For example, the rotational speed of the first pressing roll 130 may be about 1 times to about 1.1 times that of the second pressing roll 170. Within this range, it may be possible to provide a better appearance to the laminate, while reducing the sheet resistance deviation of the transparent conductor. Also the rotation direction of the first pressing roll 130 may be the same as the feeding direction of the laminate. By way of example, in the method 200, the first and second pressing rolls 130, 170 may have substantially the same rotational speed. In this case, damage to the metal nanowire may be prevented.

The second pressing roll 170 may have a rotational speed of, for example, about 1 m/min to about 20 m/min. Within this range, the sheet resistance deviation of the transparent conductor may be more effectively reduced by pressing.

By way of example, in the method 200, the nip pressure applied to the laminate by the first and second pressing rolls 130, 170 may range, for example, from about 0.2 MPa to about 10 MPa. Within this range, the sheet resistance deviation of the transparent conductor may be more effectively reduced upon pressing, while reducing the thickness of the laminate.

As used herein, “nip pressure” is obtained by measuring a pressure applied to a pressure sensitive paper sheet having a thickness of 50 μm to 75 μm (PRESCALE, Fujifilm Co., Ltd.) under the following conditions: a gap of 100 μm or less, a pressing roll rotational speed of 1 m/min to 20 m/min, and a nip pressure of 0.2 MPa to 10 MPa. Here, the pressing roll may refer to the first pressing roll; or the first and second pressing rolls. A degree of variation in color of the paper sheet when subjected to pressing under the above conditions is digitized using a dedicated scanner (FPD-8010E, Fujifilm Co., Ltd.) to calculate the nip pressure.

Referring to FIG. 2, the laminate may be transferred in a roll-to-roll manner by rolls 190 and 195, for example.

Hereinafter, a transparent conductor 300 according to an example embodiment will be described with reference to FIG. 3.

FIG. 3 is a sectional view of a transparent conductor 300 according to an example embodiment.

Referring to FIG. 3, the transparent conductor 300 according to the present example embodiment may include: a base layer 110; and a conductive layer 180 formed on the base layer 110 and including a metal nanowire and a matrix.

The base layer 110 may be a flexible insulation film. For example, the base layer 110 may be a film that includes a polyester resin, such as polyethylene terephthalate (PET) or polyethylene naphthalate; a polycarbonate resin; a cycloolefin polymer; a polyolefin resin; a polysulfone resin; a polyimide resin; a silicone resin; a polystyrene resin; a polyacryl resin; a polyvinylchloride resin; a mixture thereof, etc. In addition, the base layer may have a single layer structure, or a stack structure in which at least two resin films are stacked through adhesives and the like.

The base layer 110 may have a thickness of about 10 μm to about 100 μm, for example about 30 μm to about 100 μm, or about 40 μm to about 90 μm, or about 30 μm to about 80 μm. Within this range, the transparent conductor may be advantageously used in displays, for example, flexible displays.

The conductive layer 180 may be formed on an upper surface of the base layer 110. The conductive layer 180 includes the metal nanowires 121 and the matrix 122. The conductive layer 180 may include a conductive network formed of the metal nanowires 121, and may exhibit conductivity, good flexibility, and flexural properties. Such a conductive layer may be patterned by patterning, such as etching, to form electrodes, while ensuring flexibility for flexible devices. By way of example, the electrodes may be patterned in the form of plural lines extending in first and second directions.

The metal nanowires 121 have a nanowire shape, and may exhibit better dispersibility than metal nanoparticles. In addition, the metal nanowires 121 may considerably reduce sheet resistance of conductive films in that a nanowire shape has an advantage over a particle shape in terms of reduction in sheet resistance. The metal nanowires 121 may be prepared in the form of ultra-fine lines having a specific cross-section. By way of example, the metal nanowires 121 may have a ratio of length L to cross-section diameter d (L/d, aspect ratio) of about 10 to about 2,000. For example, the nanowire may have an L/d of about 500 to about 1,000, or about 500 to about 700. Within this range, the metal nanowire may realize a network having high conductivity even when the metal nanowire has low density, while reducing sheet resistance. The metal nanowire may have a diameter d of about 100 nm or less in cross-section. For example, the metal nanowire may have a diameter d of about 30 nm to about 100 nm, or about 60 nm to about 100 nm in cross-section. Within this range, a high L/d may be provided, which may help realize a transparent conductor having high conductivity and low sheet resistance. The metal nanowire may have a length L of about 20 μm or more. For example, the metal nanowire may have a length L of about 20 μm to about 50 μm. Within this range, a high L/d may be provided. The metal nanowire 121 may include a nanowire made of a suitable metal. For example, the metal nanowire 121 may include a silver nanowire, a copper nanowire, a gold nanowire, and mixtures thereof. By way of example, the metal nanowire may be a silver nanowire, or a mixture including the silver nanowire.

The metal nanowire 121 may be prepared by a general method, or may be a commercially available product. When using a prepared metal nanowire, the metal nanowire may be prepared by reduction of a metal salt (for example, silver nitrate (AgNO₃)) in the presence of polyol and poly(vinyl pyrrolidone). When using a commercially available product, the metal nanowire may be, for example, a ClearOhm Ink (a solution containing metal nanowires) made by Cambrios Co., Ltd. The metal nanowire may be used in a state wherein the metal nanowire is dispersed into a solution to allow easy application and improve adhesion to the base layer 110. The state wherein the metal nanowire is dispersed into a solution will be referred to as “metal nanowire dispersion” herein. The metal nanowire dispersion may include a binder to increase adhesion to the base layer 110. The metal nanowire 121 may be present in an amount of about 0.1 wt % to about 2.5 wt %, for example, about 1 wt % to about 2.5 wt % in the metal nanowire dispersion. Within this range, the metal nanowire may form a conductive network to ensure sufficient conductivity, while exhibiting adhesion to the base layer.

The matrix 122 may be impregnated with the metal nanowire 121. The metal nanowire 121 may be scattered or embedded in the matrix 122. The matrix 122 may prevent the metal nanowire 121 from being exposed above the conductive layer 180 and suffering from oxidation and abrasion. Such a matrix 122 may provide adhesion between the conductive layer 180 and the base layer 110, while improving optical properties, chemical resistance, and solvent resistance of the transparent conductor. Alternatively, the metal nanowire may partially protrude to be exposed above a surface of the matrix 122.

The matrix 122 may be formed of a matrix composition. The matrix composition may include a binder and an initiator to facilitate formation of the matrix.

The binder may include at least one of a monofunctional monomer and a polyfunctional monomer. For example, the polyfunctional monomer may include bi- to hexa-functional monomers. The monofunctional or polyfunctional monomer may be, for example, a (meth)acrylate monomer. The (meth)acrylate-based monofunctional or polyfunctional monomer may be a fluorine monomer containing fluorine, or a non-fluorine monomer free from fluorine. In addition, the (meth)acrylate-based monofunctional or polyfunctional monomer may be a non-urethane monomer free from a urethane group, and may include linear C₁ to C₂₀ alkyl group or branched C₁ to C₂₀ alkyl group-containing (meth)acrylates, hydroxyl group-containing C₁ to C₂₀ (meth)acrylates, cycloaliphatic group-containing C₃ to C₂₀ (meth)acrylates, polyfunctional (meth)acrylates of C₃ to C₂₀ polyhydric alcohols, and mixtures thereof. For example, the binder may include a pentafunctional or hexafunctional monomer; and a trifunctional monomer. The pentafunctional or hexafunctional monomer may be a pentafunctional or hexafunctional (meth)acrylate monomer containing a (meth)acrylate group, specifically, a pentafunctional or hexafunctional monomer of a C₃ to C₂₀ polyhydric alcohol. By way of example, the binder includes a non-urethane pentafunctional or hexafunctional monomer free from a urethane group, whereby the cured composition may be densely stacked within a structure of the metal nanowire 121, while improving adhesion to the base layer 110. The pentafunctional or hexafunctional monomer may include at least one of dipentaerythritol penta(meth)acrylates, dipentaerythritol hexa(meth)acrylates, caprolactone-modified dipentaerythritol penta(meth)acrylates, caprolactone-modified dipentaerythritol hexa(meth)acrylates, etc. The trifunctional monomer may be a trifunctional (meth)acrylate monomer containing a (meth)acrylate group. By way of example, the binder includes a non-urethane trifunctional monomer free from a urethane group, whereby the cured composition may be densely stacked within a structure of the metal nanowire 121, while improving adhesion to the base layer 110. The trifunctional monomer may include at least one of a trifunctional monomer of a C₃ to C₂₀ polyhydric alcohol and an alkoxy-modified trifunctional monomer of a C₃ to C₂₀ polyhydric alcohol. For example, the trifunctional monomer of a C₃ to C₂₀ polyhydric alcohol may include at least one of trimethylolpropane tri(meth)acrylates, glycerol tri(meth)acrylates, pentaerythritol tri(meth)acrylates, and dipentaerythritol tri(meth)acrylates, without being limited thereto. The alkoxy-modified trifunctional monomer of a C3 to C₂₀ polyhydric alcohol may further increase transmittance and reliability of the transparent conductor, as compared to a trifunctional monomer free from an alkoxy group, while reducing chromaticity (b*) of the transparent conductor such that a phenomenon in which the conductive layer is distorted in color to appear yellow may be prevented.

For example, the alkoxy group (for example, a C₁ to C₅ alkoxy group)-containing trifunctional monomer may be an alkoxy-modified (meth)acrylate monomer, and may include at least one of, for example, ethoxylated trimethylolpropane tri(meth)acrylates and propoxylated glyceryl tri(meth)acrylates. The pentafunctional or hexafunctional monomer and the trifunctional monomer may be present in a weight ratio of about 1:1 to about 5:1, for example, about 1:1 to about 3.5:1 in the matrix composition. Within this range, the composition may increase transmittance and reliability of the transparent conductor, while exhibiting improvement in adhesion to the substrate.

The initiator may be a general photopolymerization initiator, and may include α-hydroxyketone initiators, 1-hydroxycyclohexylphenylketone initiators, and mixtures thereof.

The conductive layer 180 may be formed by applying the metal nanowire dispersion to the base layer to form a conductive network, followed by applying the matrix composition to the conductive network.

The metal nanowire dispersion may include a binder for metal nanowires to allow easy application and improve adhesion to the base layer. The binder for metal nanowires may include, for example, carboxy methyl cellulose (CMC), 2-hydroxy ethyl cellulose (HEC), hydroxy propyl methyl cellulose (HPMC), methylcellulose (MC), poly vinyl alcohol (PVA), tripropylene glycol (TPG), polyvinylpyrrolidone binders, xanthan gum (XG), ethoxylates, alkoxylate, ethylene oxide, propylene oxide, and copolymers thereof. A method of coating the metal nanowire dispersion onto the base layer may include bar coating, spin coating, dip coating, roll coating, flow coating, die coating, and the like. The conductive network may be formed on the base layer by coating the metal nanowire dispersion onto the base layer, followed by drying. The drying may be performed, for example, at 80° C. to 140° C. for 1 minute to 30 minutes.

The matrix composition may include the binder and the initiator as described above, and may further include a solvent, as needed. The matrix composition is the same as described above. Although not particularly restricted, a method of coating the matrix composition onto the metal nanowire network may include bar coating, spin coating, dip coating, roll coating, flow coating, die coating, and the like.

The matrix composition coated onto the conductive network permeates into the conductive network. As a result, the matrix composition is impregnated with the metal nanowire, thereby forming a conductive layer including the metal nanowire and the matrix. The metal nanowire may be completely impregnated into the matrix, or may be partially exposed above the surface of the conductive layer. After coating the matrix composition, the matrix composition may be subjected to drying. For example, the coated matrix composition may be subjected to drying at 80° C. to 120° C. for 1 minute to 30 minutes. After drying, at least one of photocuring and thermo-curing may be carried out. Photocuring may be performed through light irradiation at, for example, an intensity of 300 mJ/cm² to 1000 mJ/cm² at a wavelength of 400 nm or less, and thermo-curing may include thermo-curing at, for example, 50° C. to 200° C. for 1 hour to 120 hours.

In an example embodiment, the conductive layer may be prepared separately from the base layer, followed by stacking the separately prepared conductive layer on the base layer, thereby forming the transparent conductor. In preparation of the laminate, the base layer may be subjected to, for example, plasma treatment, cleaning, and the like, whereby the transparent conductor 300 having a uniform surface may be realized.

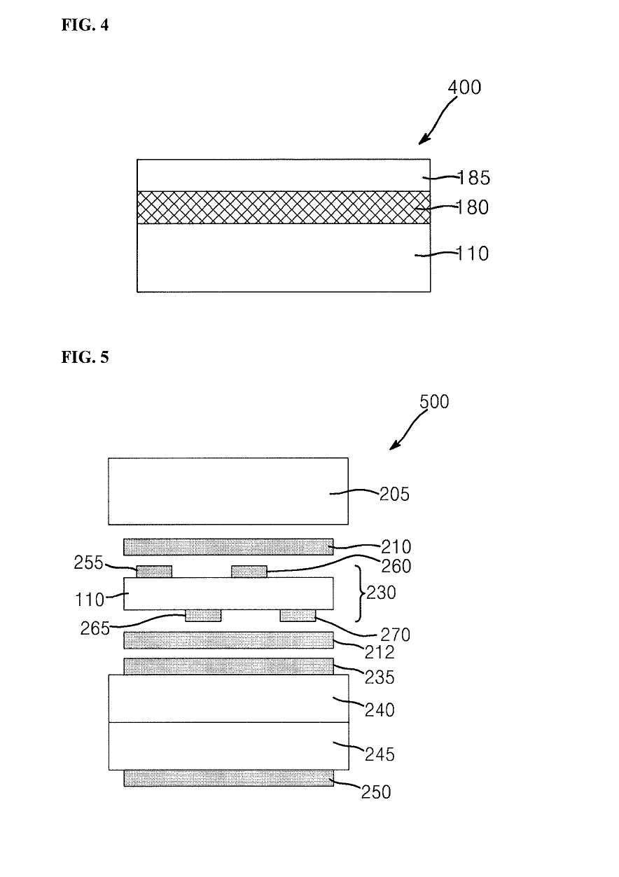

Hereinafter, a transparent conductor 400 according to another example embodiment of the invention will be described with reference to FIG. 4.

FIG. 4 is a sectional view of a transparent conductor 400 according to another example embodiment.

Referring to FIG. 4, the transparent conductor 400 according to the present embodiment includes a base layer 110, a conductive layer 180 formed on the base layer 110 and including a metal nanowire and a matrix, and an overcoating layer 185 formed on the conductive layer 180. The transparent conductor 400 according to this embodiment is substantially the same as the transparent conductor 300 (see FIG. 3) according to the above embodiment except that the overcoating layer 185 is further formed. Thus, the overcoating layer 185 will be mainly described hereinafter.

The overcoating layer 185 may help prevent oxidation of the metal nanowire due to an external environment, while improving optical properties of the transparent conductor 400, such as transparency and haze. The overcoating layer 185 may be formed by applying a composition for the overcoating layer and then curing the composition. The composition for an overcoating layer may include at least one of UV-curable resins, thermally curable resins, UV-curable monomers, and thermally curable monomers. In addition, the composition for an overcoating layer may further at least one of an initiator, an adhesion enhancer, and an antioxidant.

The adhesion enhancer may be a general silane coupling agent, and may include, for example, 3-glycidoxypropyltrimethoxysilane, 3-glycidoxypropylmethyldimethoxysilane, 2-(3,4-epoxycyclohexyl)ethyltrimethoxysilane, 3-aminopropyltrimethoxysilane, N-(2-aminoethyl)-3-aminopropyltrimethoxysilane, N-(2-aminoethyl)-3-aminopropylmethyl dimethoxysilane.

The antioxidant may include, for example, phosphorus antioxidants, phenol antioxidants, and hindered amine light stabilizer (HALS)-based antioxidants.

The initiator may be a general photopolymerization initiator, and may include a-hydroxyketone initiators, for example, 1-hydroxycyclohexylphenylketone initiators and mixtures including the same.

The transparent conductors 300 and 400 according to embodiments may have a sheet resistance deviation of less than about 20%. For example, the sheet resistance deviation of the transparent conductor may be about 16% or less. Within this range, the transparent conductor may exhibit a small increase in resistance even when the flexibility and size thereof is increased. Such a transparent conductor may be advantageously applied to large area displays, flexible displays, touchscreen panels, and the like.

The sheet resistance deviation of the transparent conductor is measured after dividing an area of the transparent conductor, as described above. Specifically, the area of the pressed transparent conductor is divided into plural sections with the same area. Thereafter, sheet resistance is measured for each section to obtain plural sheet resistance values, followed by calculating a sheet resistance deviation according to Equation 1:

Sheet resistance deviation RS_{d}=|(RSₘₐₓ−RS_{avg})/RS_{avg}×100| (1),

In Equation 1, the maximum sheet resistance RSₘₐₓ is a maximum value among the sheet resistance values measured for the plural sections, and the average sheet resistance (RS_{avg}) is an average of the maximum and minimum values RSₘₐₓ and RSₘᵢₙ among the sheet resistance values measured for the plural sections. Here, the minimum sheet resistance RSₘᵢₙ is a minimum value among the sheet resistance values measured for the plural sections.

The sheet resistance may include contact sheet resistance, non-contact sheet resistance, and the like. For example, the contact sheet resistance may be measured using an R-CHEK RC2175 (EDTM Inc), and the non-contact sheet resistance may be measured using an EC-80P (NAPSON Corporation).

The transparent conductor 300 may be transparent in a visible range, for example, at a wavelength of about 400 nm to about 700 nm. By way of example, the transparent conductor 300 may have a haze value of about 1.5% or less, for example, about 1.0% or less, as measured at a wavelength of about 400 nm to about 700 nm using a haze meter. In addition, the transparent conductor 300 may have a total luminous transmittance of about 90% or higher, specifically, about 90% to about 95%, as measured at the above wavelength.

The transparent conductor 300 may have a sheet resistance of about 150 Ω/sq or less, for example, about 50 Ω/sq to about 150 Ω/sq, or about 50 Ω/sq to about 100 Ω/sq, as measured by a 4-point probe. Within this range, the transparent conductor 300 may be advantageously used in touchscreen panels or the like by virtue of low sheet resistance thereof.

A display according to an example embodiment may include the transparent conductor as set forth above. For example, the display may include: optical displays including touchscreen panels, flexible displays, and the like; the transparent conductor may also be used in, for example, e-paper, solar cells, etc.

Hereinafter, a display according to an example embodiment of the present will be described with reference to FIG. 5.

FIG. 5 is a sectional view of a display according to an example embodiment.

Referring to FIG. 5, the optical display 500 according to the present example embodiment may include: a transparent electrode structure 230 including a base layer 110, first and second electrodes 255, 260 formed on an upper surface of the base layer 110, and third and fourth electrodes 265, 270 formed on a lower surface of the base layer 110; a window 205 placed above the first and second electrodes 255, 260; a first polarizing plate 235 placed below the third and fourth electrodes 265, 270; a color filter (CF) glass 240 formed on a lower surface of the first polarizing plate 235; a panel formed on a lower surface of the CF glass 240 and including a thin film transistor (TFT) glass 245; a second polarizing plate 250 formed on a lower surface of the TFT glass 245, wherein the transparent electrode structure 230 may be formed by patterning the transparent conductor according to embodiments (patterning may include, for example, etching) to form the first, second, third, and fourth electrodes.

The first and second electrodes 255, 260 and the third and fourth electrodes 265, 270 may be Rx electrodes and Tx electrodes, respectively, or vice versa. The window 205 performs a screen display function in the optical display, and may be prepared from glass materials or plastic materials. The first polarizing plate 235 and the second polarizing plate 250 impart polarization capabilities to the optical display to allow polarization of external or internal light, and may include a polarizer, or a stack of a polarizer and a protective film. The polarizer and the protective film may include general polarizers. Adhesive films 210, 212 may be disposed between the window 205 and the transparent electrode structure 230 and between the first polarizing plate 235 and the transparent electrode structure 230, respectively, thereby maintaining bonding between the transparent electrode structure 230, the window 205, and the first polarizing plate 235. The adhesive films 210, 212 may be general adhesive films, and may include, for example, optically clear adhesive (OCA) films.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLE 1

48 parts by weight of a metal nanowire solution (ClearOhm Ink, Cambrios Co., Ltd.) was added to 52 parts by weight of ultrapure distilled water, followed by stirring, thereby preparing a metal nanowire dispersion.

65.4 parts by weight of dipentaerythritol hexaacrylate (SK CYTEC Co., Ltd.), 20.8 parts by weight of ethoxylated trimethylolpropane triacrylate (SARTOMER Chemicals), 4.3 parts by weight of an initiator (Irgacure 184, CIBA Specialty Chemicals), 8.6 parts by weight of an adhesion enhancer (KBE-903, SHIN-ETSU Chemical), and 0.9 parts by weight of a mixture of antioxidants (Irganox 1010 and Irgafos 168, BASF Co., Ltd.) were mixed, thereby preparing a matrix composition.

The metal nanowire dispersion was coated onto a polyethylene terephthalate (PET) film, followed by drying in an oven at 80° C. for 2 minutes, thereby preparing a laminate including a base layer and a conductive network.

The laminate was subjected to pressing by rotating ebonite rolls (sulfur content 25%), while transferring the laminate on a conveyor belt, thereby preparing a transparent conductor.

Here, the nip pressure (nip pressure) was 0.7 MPa, and the feeding speed of the laminate was 1 m/min.

Thereafter, the matrix composition was coated onto the conductive network to form a coating layer to a thickness of 50 nm. Next, after drying in an oven at 80° C. for 2 minutes, the coated composition was cured through UV irradiation at 300 mJ/cm², thereby preparing a laminate including the base layer and a conductive layer.

### EXAMPLE 2

48 parts by weight of a metal nanowire solution (ClearOhm Ink, Cambrios Co., Ltd.) was added to 52 parts by weight of ultrapure distilled water, followed by stirring, thereby preparing a metal nanowire dispersion.

65.4 parts by weight of dipentaerythritol hexaacrylate (SK CYTEC Co., Ltd.), 20.8 parts by weight of ethoxylated trimethylolpropane triacrylate (SARTOMER Chemicals), 4.3 parts by weight of an initiator (Irgacure 184, CIBA Specialty Chemicals), 8.6 parts by weight of an adhesion enhancer (KBE-903, SHIN-ETSU Chemical), and 0.9 parts by weight of a mixture of antioxidants (Irganox 1010 and Irgafos 168, BASF Co., Ltd.) were mixed, thereby preparing a matrix composition.

The metal nanowire dispersion was coated onto a polyethylene terephthalate (PET) film, followed by drying in an oven at 80° C. for 2 minutes, thereby preparing a laminate including a base layer and a conductive network.

The laminate was subjected to pressing while passing between an ebonite roll (a first pressing roll) and a SUS/Cr roll (a second pressing roll) adjacent to the ebonite roll with a predetermined gap therebetween. During pressing, the ebonite roll was brought into contact with the conductive layer, whereas the SUS/Cr roll was brought into contact with the PET film. Here, pressing was performed under the following conditions: a nip pressure of 0.7 MPa, a gap of 0 μm, and a laminate feeding speed of 1 m/min. The ebonite roll and the SUS/Cr roll had the same rotational speed.

Thereafter, the matrix composition was coated onto the conductive network to form a coating layer to a thickness of 50 nm. Next, after drying in an oven at 80° C. for 2 minutes, the coated composition was cured through UV irradiation at 300 mJ/cm², thereby preparing a laminate including the base layer and a conductive layer.

### COMPARATIVE EXAMPLE 1

A transparent conductor was prepared in the same manner as in Example 2 except that the ebonite roll was replaced with a nitrile butadiene rubber (NBR) roll with the same diameter.

### COMPARATIVE EXAMPLE 2

A transparent conductor was prepared in the same manner as in Example 2 except that the ebonite roll was replaced with a silicon rubber (RTV) roll with the same diameter. Here, the silicon rubber roll had a surface roughness of 0.8 S.

### COMPARATIVE EXAMPLE 3

A transparent conductor was prepared in the same manner as in Example 2 except that the ebonite roll was replaced with an SUS/Cr roll with the same diameter.

Each of the transparent conductors prepared in Examples and Comparative Examples was evaluated as to physical properties using the following methods. Results are shown in Table 1.

<Evaluation Method>

(1) Sheet resistance deviation: The surface of the transparent conductor was divided into plural sections with the same area, followed by measuring sheet resistance (unit: Ω/sq) for each section. Non-contact sheet resistance was measured using an EC-80P (NAPSON Corporation). Sheet resistance deviation was calculated by substituting the measured sheet resistance values for the plural sections into Equation 1:

Sheet resistance deviation (RS_{d})=|(RSₘₐₓ-RS_{avg})RS_{avg}×100| (1),

In Equation 1, the maximum sheet resistance RSₘₐₓ is a maximum value among the sheet resistance values measured for the plural sections, and the average sheet resistance RS_{avg} is an average of the maximum and minimum values RSₘₐₓ and RSₘᵢₙ among the sheet resistance values measured for the plural sections. Here, the minimum sheet resistance RSₘᵢₙ is a minimum value among the sheet resistance values measured for the plural sections.

(2) Appearance: The surface on the conductive layer side of the transparent conductor was observed through an optical microscope, followed by comparing the obtained images with one another. Occurrence of tearing of the silver nanowire and occurrence of scratching were determined. Evaluation criteria were as follows.

Good: Neither tearing nor scratching.

Poor: Occurrence of tearing and/or scratching.

TABLE 1

| | | | | | Property evaluation result | | | |
|---|---|---|---|---|---|---|---|---|
| | | | | | Sheet | | | |
| | First pressing roll | | Second pressing roll | | resistance | Tearing of | | |
| | | Surface | | Surface | deviation | silver | | Comprehensive |
| | Material | hardness | Material | hardness | (%) | nanowire | Scratching | evaluation |
| Example 1 | Ebonite | D-80 | No | | 16 | No | No | Good |
| Example 2 | Ebonite | D-80 | SUS/Cr | D-100 or | 16 | No | No | Good |
| | | | | higher | | | | |
| Comp. | NBR | A-80 | SUS/Cr | D-100 or | 60 | Yes | No | Poor |
| Example 1 | | | | higher | | | | |
| Comp. | RTV | A-80 | SUS/Cr | D-100 or | 60 | Yes | No | Poor |
| Example 2 | (silicone) | | | higher | | | | |
| Comp. | SUS/Cr | D-100 or | SUS/Cr | D-100 or | 30 | No | Yes | Poor |
| Example 3 | | higher | | higher | | | | |

* Surface hardness of pressing rolls: Measured results in accordance with ASTM D2240.

As shown in Table 1, it was ascertained that, in the transparent conductors prepared by the method according to an embodiment, neither tearing of the metal nanowire nor scratching has occurred, thereby securing low sheet resistance deviation and a good appearance.

Conversely, as shown in Table 1, in the transparent conductors of Comparative Examples 1 to 2 prepared using the NBR or silicon roll (having a lower Shore hardness than the roll of the Examples) as the first pressing roll, although scratching did not occur, tearing of the metal nanowires occurred. As a result, the transparent conductors exhibited a higher sheet resistance deviation and a poor appearance.

In addition, as shown in Table 1, in the transparent conductor of Comparative Example 3 prepared using the SUS/Cr roll with a considerably higher Shore hardness than the roll of the Examples as the first pressing roll, although tearing of the metal nanowires did not occur, scratching occurred. As a result, the transparent conductor exhibited a higher sheet resistance deviation and a poor appearance.

By way of summation and review, a transparent conductor may be a laminate including a base layer and a conductive layer. The conductive layer may be formed on the base layer, and may include metal nanowires and a matrix. In this regard, US Patent Publication No. 2007/0074316 discloses a method for preparing a transparent conductor. US Patent Publication No. 2007/0074316 is incorporated by reference herein for all purposes.

It is desirable for a transparent conductor to have high conductivity while exhibiting a low sheet resistance deviation. For this purpose, transparent conductors may be prepared by pressing, in which the laminate including the base layer and the conductive layer is pressed by a pressing roll. A general pressing method may employ a pressing roll made of a general rubber. However, the pressing roll made of rubber may cause tearing of the metal nanowire, or scratching at a surface of the transparent conductor. Consequently, the general method for preparing a transparent conductor may yield a transparent conductor that has a high sheet resistance deviation and low conductivity, and also exhibits deteriorated appearance.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. A method for preparing a transparent conductor, the method comprising:
providing a laminate, the laminate including:
a base layer, and
a conductive network on the base layer and including metal nanowires; and
pressing the laminate using a first pressing roll that has a surface hardness of about Shore D-50 to about Shore D-90.

2. The method as claimed in claim 1, wherein the first pressing roll has a coefficient of friction of less than about 0.8.

3. The method as claimed in claim 1, wherein the first pressing roll has a vulcanized rubber surface, and the vulcanized rubber has a sulfur content of 20 wt % or more.

4. The method as claimed in claim 1, wherein the pressing is performed using a second pressing roll facing the first pressing roll at a predetermined distance therefrom.

5. The method as claimed in claim 4, wherein the second pressing roll has a higher Shore D surface hardness than the first pressing roll.

6. The method as claimed in claim 4, wherein the second pressing roll has a stainless steel surface or a chrome-coated stainless steel surface.

7. The method as claimed in claim 4, wherein a nip pressure applied to the laminate by the first and second pressing rolls ranges from about 0.2 MPa to about 10 MPa.

8. The method as claimed in claim 1, further comprising, after pressing the laminate, applying a matrix composition to the conductive network and curing the matrix composition to form a conductive layer.

9. The method as claimed in claim 8, wherein the matrix composition includes a hexafunctional acrylate monomer and a trifunctional acrylate monomer.

10. The method as claimed in claim 8, further comprising patterning the conductive layer.

11. The method as claimed in claim 1, wherein the metal nanowires include silver nanowires.

12. A pressing roll for preparing a transparent conductor from a laminate that includes a base layer and a conductive layer, the conductive layer being on the base layer and including metal nanowires and a matrix, the pressing roll comprising:
a first pressing roll having a surface hardness of about Shore D-50 to about Shore D-90; and
a second pressing roll disposed opposite the first pressing roll and configured to press the laminate therebetween.

13. The pressing roll as claimed in claim 12, wherein the first pressing roll has a vulcanized rubber surface, and the vulcanized rubber has a sulfur content of 20 wt % or more.

14. The pressing roll as claimed in claim 12, wherein the second pressing roll has a stainless steel surface or a chrome-coated stainless steel surface.

15. A transparent conductor, comprising:
a base layer; and
a conductive layer on the base layer and including metal nanowires and a matrix,
the transparent conductor having a sheet resistance deviation of less than about 20%, as represented by Equation 1:
Sheet Resistance Deviation RS_{d}=|(RSₘₐₓ−RS_{avg})/RS_{avg}×100| (1),
wherein, in Equation 1, the maximum sheet resistance RSₘₐₓ is a maximum value among sheet resistance values measured for plural sections, and the average sheet resistance RS_{avg} is an average of the maximum sheet resistance RSₘₐₓ and minimum sheet resistance RSₘᵢₙ values among the sheet resistance values measured for the plural sections, the minimum sheet resistance RSₘᵢₙ being a minimum value among the sheet resistance values measured for the plural sections.

16. The transparent conductor as claimed in claim 15, wherein the transparent conductor is formed by pressing a laminate using a first pressing roll having a surface hardness of about Shore D-50 to about Shore D-90, the laminate including the base layer and a conductive network containing the metal nanowires on the base layer.

17. The transparent conductor as claimed in claim 15, wherein the matrix is formed of a composition containing a hexafunctional acrylate monomer and a trifunctional acrylate monomer.

18. The transparent conductor as claimed in claim 15, wherein the first pressing roll has a vulcanized rubber surface, and the vulcanized rubber has a sulfur content of 20 wt % or more.

19. The transparent conductor as claimed in claim 15, wherein the pressing is performed using a second pressing roll facing the first pressing roll at a predetermined distance therefrom.

20. A display comprising the transparent conductor as claimed in claim 15.
